(19) United States
(12) Patent Application Publication
(10) Pub. No.: US 2004/0226773 A1
(43) Pub. Date: Nov. 18, 2004

(54) Rotation limiter for center-folding ladder

(76) Inventors: Jeffrey Beaver, Indianapolis, IN (US); Tom Meyers, Fishers, IN (US)

Correspondence Address: BARNES & THORNBURG, 11 SOUTH MERIDIAN, INDIANAPOLIS, IN, 46204

(21) Appl. No.: 10/808,911

(22) Filed: Mar. 25, 2004

Related U.S. Application Data
(60) Provisional application No. 60/467,220, filed on May 1, 2003.

(51) Int. Cl. E06C 1/00

(52) U.S. Cl. 182/163; 182/23

(57) ABSTRACT

A hinge and locking assembly includes a first support plate, a second support plate coupled to the first support plate for pivoting movement about an axis, a knob rotatable about the axis and a rotation limiter. The knob is movable axially along the axis between a first axial position and a second axial position The second support plate has a first tab-receiving space. The knob has a second tab-receiving space. The rotation limiter includes a slip disc rotatable about the axis and having first and second tabs. The first tab moves into the first tab-receiving space when the knob is moved from the first position to the second position. The second tab is received in the second tab-receiving space.

This application claims priority under 35 U.S.C. § 119(e) to U.S. Provisional Application Ser. No. 60/467,220, filed May 1, 2003, which is expressly incorporated by reference herein.

### BACKGROUND

The present disclosure relates to a center-folding ladder, and more particularly to a hinge and locking assembly for a center-folding ladder.

Ladders are commonly used for a variety of applications and are of two general types. One type is a center-folding ladder, commonly called a step ladder, which is self-supporting. Step ladders are typically used for such tasks as pruning, painting ceilings, or other similar tasks where it is difficult or inconvenient to lean the ladder against a structure, such as a wall, for support. The other type of ladder is the straight extension ladder. This type of ladder is simply leaned against the wall or some other structure when standing or climbing on the ladder.

Ladders which are constructed so that they may be used as both step ladders and as straight extension ladders have been known in the art. Such ladders, commonly referred to as combination step and extension ladders, are very versatile and they combine the desirable features of both types of ladders. Such combination ladders typically include a hinge and locking assembly at each end. The hinge and locking assemblies permit the ladder to be folded into and locked in a step ladder configuration or unfolded into and locked in a straight extension ladder configuration. Examples of combination ladders are U.S. Pat. Nos. 3,912,043; 4,566,150; and 4,770,559 which are incorporated herein by reference.

### SUMMARY

One or more of the following features or elements or combinations thereof may be incorporated into a hinge and a locking assembly.

A hinge and locking assembly is provided. Such an assembly may be used, for example, to couple sections of a center-folding ladder. It will be appreciated that such an assembly may have various uses. Such a hinge and locking assembly permits the ladder to be folded into and locked in a step ladder configuration or unfolded into and locked in an extension ladder configuration. The hinge and locking assembly does not lock the ladder as the ladder passes through the step ladder configuration during movement of the ladder from the extension ladder configuration to the collapsed configuration.

The assembly comprises a pair of support plates, a locking bar and a lifting cam. The support plates are rotatable relative to each other about a common axis. Each plate has at least one locking slot. The locking bar has at least one locking tab configured to engage the locking slots in the support plates to block relative movement of the support plates relative to each other. The lifting cam is configured to move the locking bar relative to the support plates to selectively disengage the locking tab from the locking slots in the support plates to permit relative movement of the support plates relative to each other.

The assembly includes a drive shaft rotatable about the common axis and the lifting cam is coupled to drive shaft for rotation therewith. The locking bar is coupled to the drive shaft for axial movement relative to the support plates. The locking bar has a pair of axially-extending locking tabs which are spaced at equal radial distances from the common axis on the opposite sides thereof along a line that extends through the common axis.

A first one of the support plates has a pair of locking slots. The locking slots may be axially extending. The locking slots may be radially extending. The locking slots may be peripherally or circumferentially-spaced. The locking slots may be spaced at equal radial distances from the common axis on the opposite sides of the common axis along a line that extends through the common axis. Each locking slot may be circular, rectangular, square, or any other suitable shape.

A second one of the support plates has a first pair of locking slots so that the locking tabs of the locking bar can extend through the pair of locking slots in the first support plate and the first pair of locking slots in the second support plate in a first configuration of the support plates. The first pair of locking slots may be axially extending. The first pair of locking slots may be radially extending. The first pair of locking slots may be peripherally or circumferentially-spaced. The first pair of locking slots may be spaced at equal radial distances from the common axis on the opposite sides of the common axis along a line that extends through the common axis. Each of the first pair of locking slots may be circular, rectangular, square, or any other suitable shape.

The second support plate has a second pair of locking slots so that the locking tabs of the locking bar can extend through the pair of locking slots in the first support plate and the second pair of locking slots in the second support plate in a second configuration of the support plates. The second pair of locking slots may be axially extending. The second pair of locking slots may be radially extending. The second pair of locking slots may be peripherally or circumferentially-spaced. The second pair of locking slots may be spaced at equal radial distances from the common axis on the opposite sides of the common axis along a line that extends through the common axis. Each of the second pair of locking slots may be circular, rectangular, square, or any other suitable shape.

The first and second pairs of axially-extending locking slots in the second support plate are arranged to form an acute angle relative to each other. The assembly includes a spring for biasing the locking bar toward the support plates so that the locking tabs extend through the locking slots in the support plates to block relative movement of the support plates relative to each other.

Features of the present disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a center-folding ladder having at each end a pair of legs coupled together by a hinge and locking assembly in accordance with this disclosure which permit the ladder to be folded into and locked in a step ladder configuration or unfolded into and locked in a straight extension ladder configuration,

FIGS. 2-4 are end views showing the ladder moving from a collapsed configuration in FIG. 2 (also referred to as a 0° configuration), to a step ladder configuration in FIG. 3 (also referred to as a folded or 40° configuration) and then to a straight extension ladder configuration in FIG. 4 (also referred to as a fully open or 180° configuration),

FIGS. 5-7 are end views similar to FIGS. 2-4 showing the ladder moving from the extension ladder configuration in FIG. 5 to the collapsed configuration in FIG. 7 through an intermediate configuration in FIG. 6,

FIG. 8 is an exploded perspective view of a first embodiment of a hinge and locking assembly, and showing, from left to right, front outer covers, locking bar support pin, locking bar, snap spring, knob support pin, drive shaft (also referred to as cam drive shaft), tri-lobe lifting cam, front support plate, rear support plate, locking plate, detent plate, spring clip, knob spring, winged hex drive, lock washer, rear outer covers, and knob,

FIG. 9 is an exploded perspective view, similar to FIG. 8, of a second embodiment of a hinge and locking assembly having knob rotation limiter and hinge lock indicator features, and showing, from left to right, front outer covers, locking bar support pin, locking bar, snap spring, drive shaft, lifting cam, front support plate, spacer, rear support plate, locking plate, detent plate, spring clip, knob spring, knob assembly, and rear outer covers,

FIG. 10 is an exploded perspective view of the knob assembly of FIG. 9, and showing, from left to right, lock washer, slip disc, slip disc rotation spring and knob,

FIG. 11 is a perspective view of the knob of FIG. 10 showing a pair of forwardly-extending radial ribs,

FIG. 12 is a perspective view of the locking plate of FIG. 9,

FIG. 13 is an elevation view of the locking plate of FIG. 12 as viewed from the end of the FIG. 9 hinge and locking assembly having the knob assembly, and

FIG. 14 shows details of the locking plate.

### DETAILED DESCRIPTION

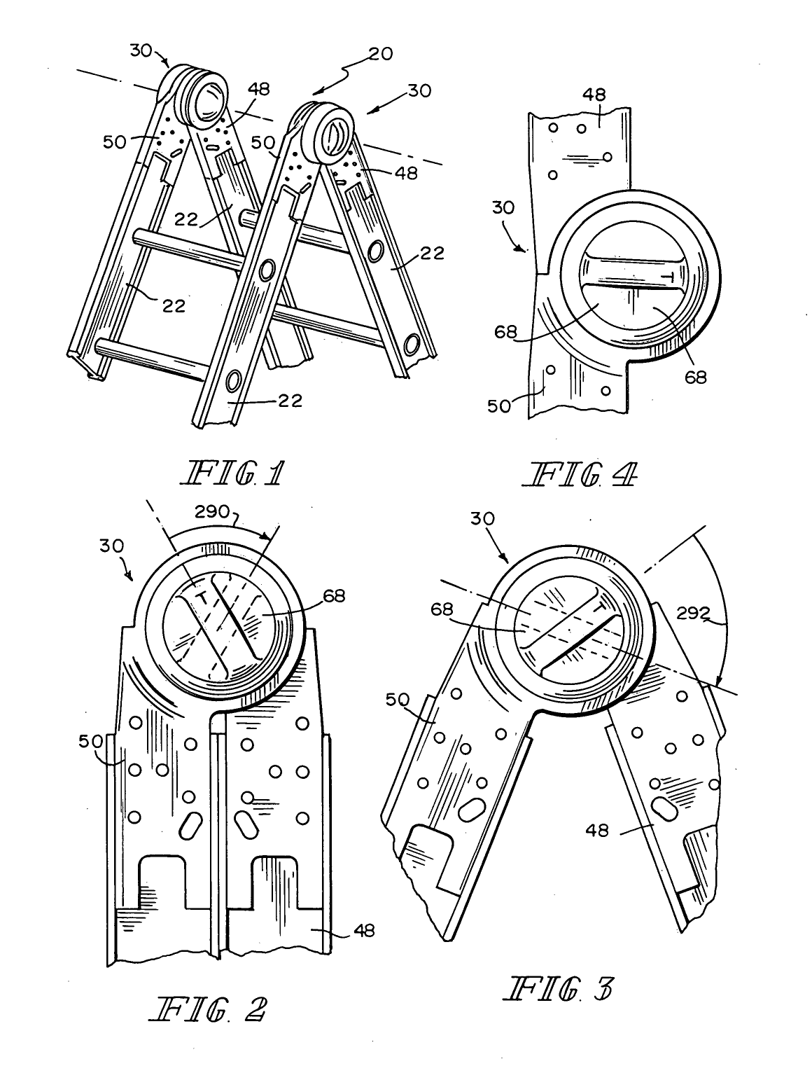

A perspective view of a center-folding ladder 20 having at each end a pair of legs 22 coupled together by a hinge and locking assembly 30 is shown in FIG. 1. The hinge and locking assembly 30 at each end permits the ladder 20 to be folded into and locked in a step ladder configuration shown in FIG. 3 or unfolded into and locked in an extension ladder configuration as shown in FIG. 4. To move the ladder 20 from the collapsed configuration in FIG. 2 to the step ladder configuration shown in FIG. 3, each knob 68 is pushed inward and rotated 60° clockwise (identified by numeral 290 in FIG. 2) to unlatch the hinge and locking assemblies 30 and the legs 22 are then spread apart. The rotated position of the knob 68 is shown by the dotted lines in FIG. 2. When the legs 22 move to the step ladder configuration shown in FIG. 3, the hinge and locking assemblies 30 automatically latch to lock the legs 22 securely in the step ladder configuration.

To move the ladder 20 from the step ladder configuration in FIG. 3 to the extension ladder configuration shown in FIG. 4, each knob 68 is again pushed inward and rotated 60° clockwise (identified by numeral 292 in FIG. 3) to unlatch the hinge and locking assemblies 30 and the legs 22 are then moved to the fully open position. The rotated position of the knob 68 is shown by the dotted lines in FIG. 3. When the legs 22 move to the extension ladder configuration shown in FIG. 4, the hinge and locking assemblies 30 automatically latch to securely lock the legs 22 in the extension ladder configuration.

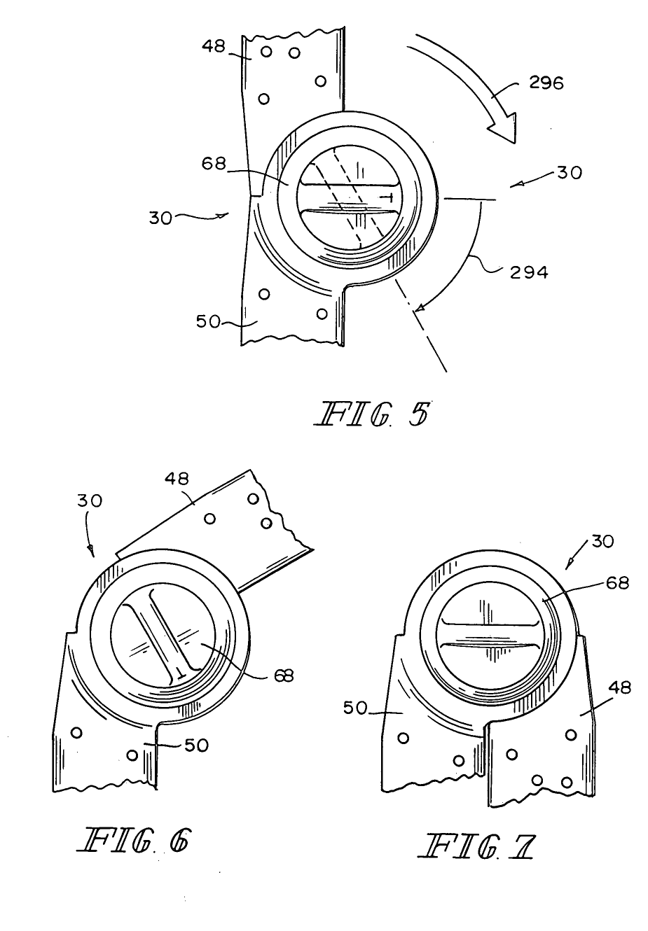

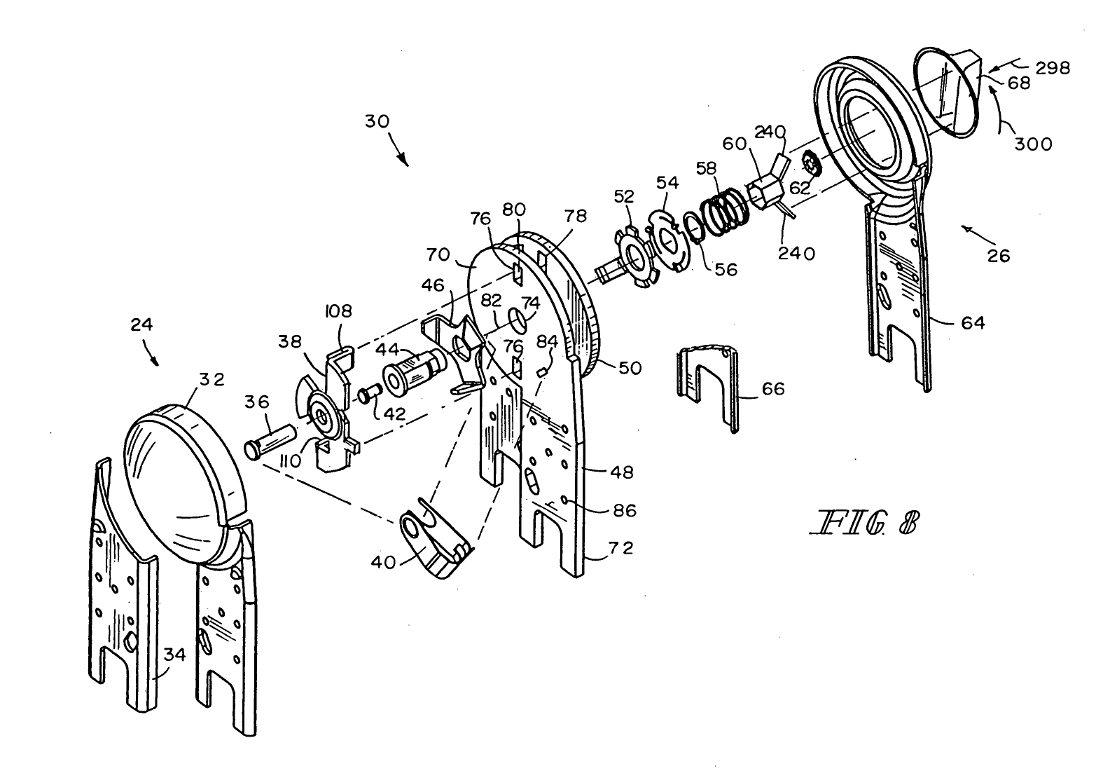

To move the ladder 20 from the extension ladder configuration in FIG. 5 to the collapsed configuration shown in FIG. 7, each knob 68 is again pushed inward and rotated 60° clockwise (identified by numeral 294 in FIG. 5) to unlatch the hinge and locking assemblies 30 and the legs 22 are brought together as shown in FIGS. 6 and 7. The rotated position of the knob 68 is shown by the dotted lines in FIG. 5, and the direction of rotation is shown therein by numeral 296. When the legs 22 move to the collapsed configuration shown in FIG. 7, the hinge and locking assemblies 30 automatically latch to lock the legs 22 securely in the collapsed configuration. The hinge and locking assemblies 30 do not lock the ladder as the ladder 20 passes through the step ladder configuration during movement of the ladder 20 from the extension ladder configuration in FIG. 5 to the collapsed configuration in FIG. 7. The two hinge and locking assemblies 30 on the opposite sides of the center-folding ladder 20 are identical.

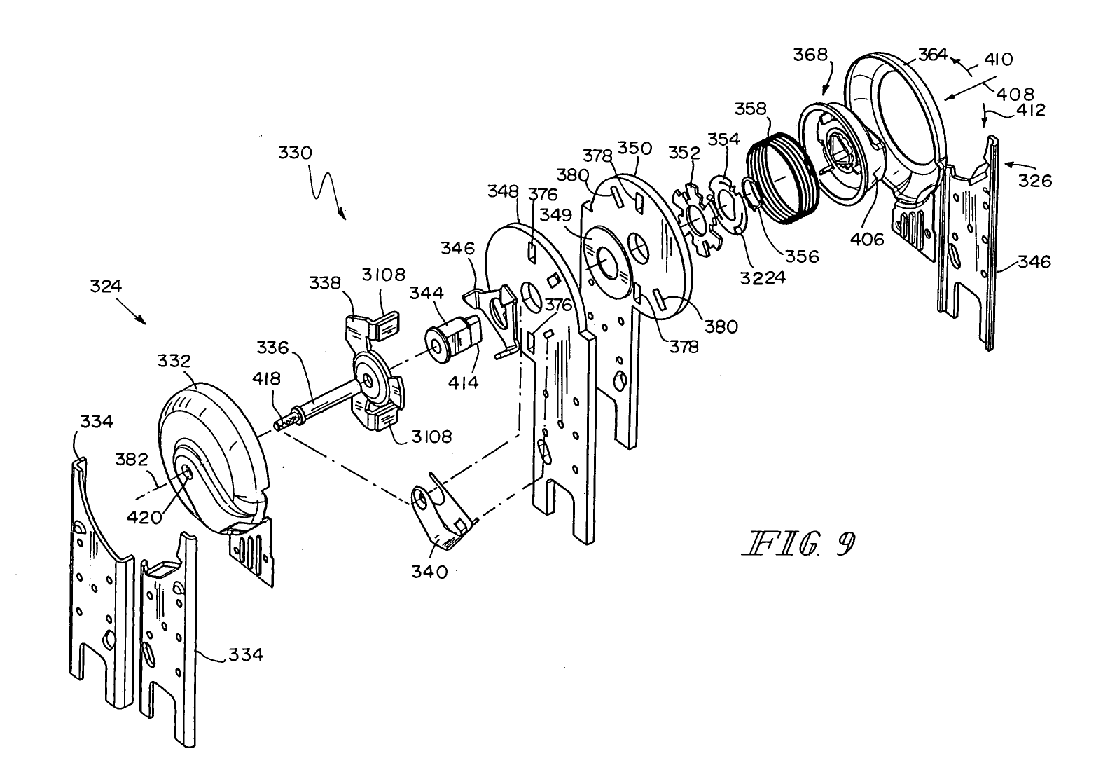

An exploded perspective view of a first embodiment 30 of the hinge and locking assembly that does not have knob rotation limiter and hinge lock indicator features is shown in FIG. 8. The knob rotation limiter and the hinge lock indicator features are described below in conjunction with the description of the second embodiment 330 of the hinge and locking assembly of FIGS. 9-14. As shown in FIG. 8, the hinge and locking assembly 30 includes, from left to right, front outer covers 32, 34, a locking bar support pin 36, a locking bar 38, a U-shaped snap spring 40 (also referred to as the formed spring), a knob support pin 42, a drive shaft 44 (also referred to as the cam shaft), a tri-lobe lifting cam 46, a front support plate 48, a rear support plate 50, a locking plate 52, a detent plate 54, a spring clip 56, a knob spring 58, a winged hex drive 60, a lock washer 62, rear outer covers 64, 66, and a lock release knob 68.

In this disclosure, the terms “front”, “raised”, “advanced”, “upward”, “forward” and “head end” all mean toward the end 24 of the hinge and locking assembly 30 having the locking bar 38 and the lifting cam 46. On the other hand, the terms “back”, “lowered”, “retracted”, “backward”, “downward”, “rear” and “foot end” mean toward the end 26 of the hinge and locking assembly 30 having the knob 68. Unless specified otherwise, all rotational directions (clockwise or anticlockwise) are referenced from the end 26 of the hinge and locking assembly 30 having the knob 68. Also, the terms “slot”, “hole”, “opening”, “aperture”, etc. are synonymous in this disclosure.

Hinge and locking assembly 30 is described in detail in a U.S. patent application (Attorney Docket No.20341-73011), filed on ______, Ser. No. ______, and entitled “Hinge and Locking Assembly For Center-Folding Ladder”, which is hereby incorporated by reference in its entirety. The operation of the hinge and locking assembly 30 is, however, briefly summarized below.

To move the ladder 20 from the collapsed configuration shown in FIG. 2 to the step ladder configuration shown in FIG. 3, the knob 68 is first pushed inward against the knob spring 58 in a direction 298 to cause the hex drive 60 to engage a hex drive portion of the drive shaft 44 so that the knob 68 can be rotated about 60° in a clockwise direction 300 to, in turn, rotate the drive shaft 44 and the lifting cam 46 also about 60° in the clockwise direction 300. As the lifting cam 46 rotates, the inclined leading edges of the lifting cam 46 engage the corresponding leading edges of the locking bar 38 to lift the locking bar 38 away from the support plates 48, 50 against the force of the snap spring 40. Lifting the locking bar 38 away from the support plates 48, 50 withdraws the locking tabs 108, 110 out of the locking slots 78 in the rear support plate 50 to unlock the hinge and locking assembly 30 to, in turn, permit relative movement of the support plates 48, 50 relative to each other. The legs 22 of the ladder 20 are then spread apart. When the ladder 20 arrives at the step ladder configuration shown in FIG. 3, the locking tabs 108, 110 are driven through the slots 80 in the rear support plate 50 to lock the hinge and locking assembly 30.

To move the ladder 20 from the step ladder configuration shown in FIG. 3 to the extension ladder configuration shown in FIG. 4, the hinge and locking assembly 30 is again unlocked by pushing the knob 68 inward and turning it through about 60° in the clockwise direction 300. As previously indicated, clockwise rotation of the knob 68 through about 60° causes clockwise rotation of the drive shaft 44 and the lifting cam 46 also through about 60° in the clockwise direction. As the lifting cam 46 rotates, the locking bar 38 is lifted away from the support plates 48, 50 against the force of the snap spring 40. Lifting the locking bar 38 away from the support plates 48, 50 withdraws the locking tabs 108, 110 out of the locking slots 80 in the rear support plate 50 to unlock the hinge and locking assembly 30 to, in turn, permit relative movement of the support plates 48, 50 relative to each other. The legs 22 of the ladder 20 are then spread apart. When the ladder 20 arrives at the extension ladder configuration shown in FIG. 4, the locking tabs 108, 110 are driven through the slots 78 in the rear support plate 50 to lock the hinge and locking assembly 30 in the extension ladder configuration.

To move the ladder 20 back to the collapsed configuration shown in FIG. 2, the hinge and locking assembly 30 is unlocked by pushing the knob 68 inward and turning it through about 60° in the clockwise direction 300. Rotation of the knob 68 causes the locking bar 38 to move away from the support plates 48, 50 to permit relative movement of the support plates 48, 50 relative to each other. The legs 22 of the ladder 20 are then brought together. When the legs 22 again arrive at the collapsed configuration in FIG. 2, the locking tabs 108, 110 are driven through the slots 78 in the rear support plate 50 to lock the assembly 30 in the collapsed configuration. It is noted that while the tabs 108, 110 are withdrawn from the slots 78 or 80 in the rear support plate 50 when the locking bar 38 is lifted, the tabs 108, 110 remain extended into the slots 76 in the front support plate 48. As previously indicated, the assembly and operation of the hinge and locking assembly 30 is described in detail in the afore-mentioned U.S. patent application (Attorney Docket No. 20341-73011), Ser. No. ______.

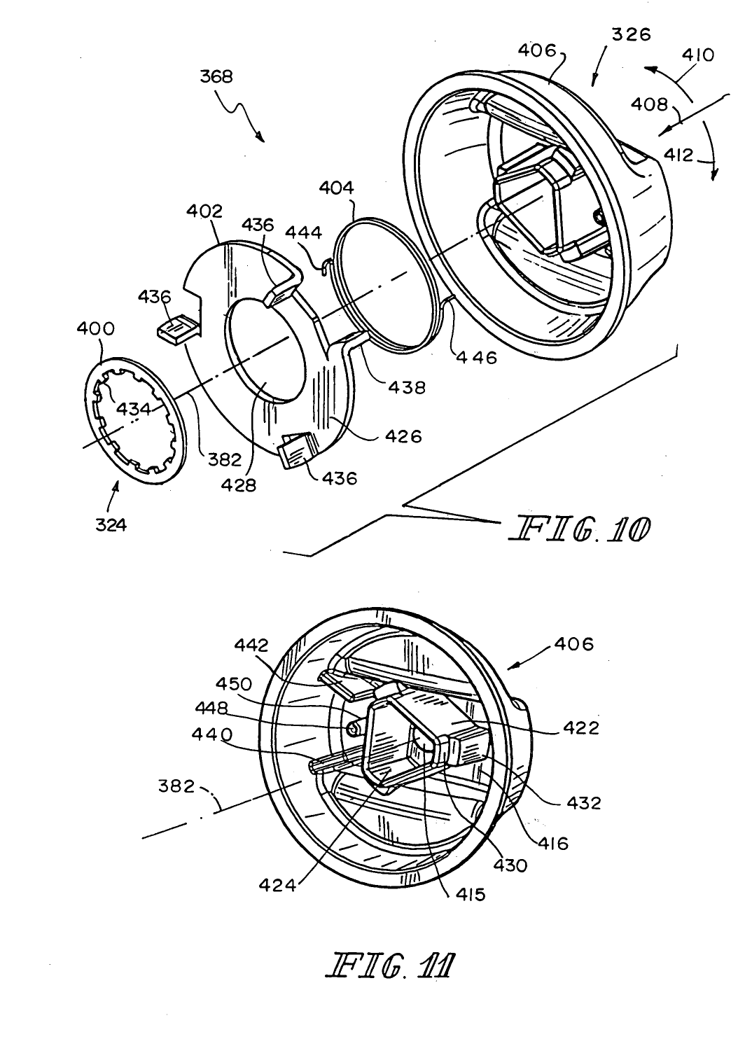

An exploded perspective view, similar to FIG. 8, of the second embodiment 330 of the hinge and locking assembly having the knob rotation limiter and the hinge lock indicator features is shown in FIG. 9. Like elements in the two embodiments 30, 330 generally bear the same reference numerals, except that the reference numerals in the second embodiment 330 are preceded by a numeral “3”. Thus, the hinge and locking assembly 330 includes, from left to right, front outer covers 332, 334, a locking bar support pin 336, a locking bar 338, a snap spring 340, a drive shaft 344, a lifting cam 346, a front support plate 348, a spacer 349, a rear support plate 350, a locking plate 352, a detent plate 354, a spring clip 356, a knob spring 358, a knob assembly 368, and rear outer covers 364, 366. The locking plate 352 is sometimes referred to herein as the locking member and the detent plate 354 is sometimes referred to herein as the detent member. In FIG. 9, numerals 324, 326, and 382 refer to the front end, the back end and the common axis of the hinge and locking assembly 330. As shown in FIG. 10, the knob assembly 368 includes, from left to right, a lock washer 400, a slip disc 402, a slip disc rotation spring 404, and a knob 406. As indicated above, all rotational directions (clockwise or anticlockwise) are referenced from the end 326 of the assembly 330 having the knob assembly 368.

The slip disc 402 cooperates with the locking plate 352 to provide the knob rotation limiter feature which limits the rotation of the knob 406 to about 60° to 70° each time the knob 406 is pushed inward in direction 408 against the bias of the knob spring 358 and turned in a clockwise direction 410 to unlock the hinge and locking assembly 330. Each time the knob 406 is pushed in and turned clockwise to unlock the hinge and locking assembly 330, the knob 406 must be first released so that the slip disc 402 resets itself before the knob 406 can be operated again to unlock the hinge and locking assembly 330 a second time. This ensures that the user does not overshoot the rotation of the knob 406 beyond 60° to 70° required to unlock the hinge and locking assembly 330 to maintain the integrity of the operation of the hinge and locking assembly 330.

Unlike the first embodiment 30, the hinge and locking assembly 330 does not include a knob support pin, such as the knob support pin 42 in FIG. 8. Instead, the knob 406 is slidably supported on a rearwardly extending portion 414 of the drive shaft 344. The locking bar support pin 336 is fixed to the locking bar 338. The locking bar support pin 336 extends through the drive shaft 344 near the knob 406 and engages a forwardly-extending boss 415 on the inside wall 416 (FIG. 11) of the knob 406 so that, when the knob 406 is pushed inward in direction 408, a forwardly-extending terminal portion 418 of the locking bar support pin 336 extends through a window 420 in the front cover 332 to provide visual indication that the knob 406 is pushed in. Thus, when the knob 406 is pushed in and turned clockwise to unlock the hinge and locking assembly 330, the forwardly-extending portion 418 of the locking bar support pin 336 extends through the window 420 in the front cover 332 to provide visual indication that the hinge and locking assembly 330 is unlocked. The terminal portion 418 of the locking bar support pin 336 may be painted with a suitable color, such as red, to warn the user when the hinge and locking assembly 330 is unlocked. This feature is referred to herein as the hinge lock indicator feature.

Referring to FIGS. 10 and 11, the knob 406 includes a triangular-shaped hub portion 422 extending forwardly from the inside wall 416 of the knob 406. The triangular-shaped hub portion 422 has a triangular-shaped bore 424. The walls defining the triangular-shaped hub portion 422 are generally congruent with the walls of the triangular-shaped bore 424. The triangular-shaped rearwardly-extending portion 414 of the drive shaft 344 is slidably received in the triangular-shaped bore 424 in the knob 406 to rotationally couple the knob 406 to the drive shaft 344. The triangular-shaped portion 414 of the drive shaft 344 is sized for a close-fit sliding reception in the triangular-shaped bore 424 so that the knob 406 can freely slide back-and-forth relative to the drive shaft 344 while transmitting the rotation of the knob 406 to the drive shaft 344. As in the first embodiment 30, the knob 406 and the drive shaft 344 can only rotate in the clockwise direction 410. The locking plate 352 and the detent plate 354 cooperate to prevent the knob 406 and the drive shaft 344 from rotating in the counterclockwise direction 412.

The slip disc 402 includes an annular portion 426 having a central bore 428 configured to rotatably receive the triangular-shaped hub portion 422 of the knob 406. The triangular-shaped hub portion 422 has rounded corner portions 430 to facilitate rotation of the slip disc 402 relative to the knob 406 about the common axis 382 of the hinge and locking assembly 330. The central bore 428 in the slip disc 402 and the hub portion 422 of the knob 406 are so sized that that the slip disc 402 is free to rotate and slide back-and-forth relative to the hub portion 422. Each rounded corner portion 430 of the knob 406 is formed include an outwardly-extending step portion 432. The slip disc 402 and the slip disc rotation spring 404 are positioned on the hub portion 422 of the knob 406 between the step portions 432 and the lock washer 400.

The lock washer 400 includes inwardly-extending teeth 434 along its inner periphery which are configured to engage the rounded corner portions 430 of the hub portion 422 to secure the lock washer 400 to the hub portion 422. The inside diameter of the inwardly-extending teeth 434 and the outside diameter of the hub portion 422 are dimensioned to provide friction or interference fit. The slip disc rotation spring 404 biases the slip disc 402 in the clockwise direction 410 relative to the knob 406 to transmit the rotation of the knob 406 to the slip disc 402.

The slip disc 402 has three radially-extending tabs 436 which extend forwardly toward the locking plate 352 secured to the rear support plate 350. The slip disc 402 has one radially-extending tab 438 which extends rearwardly toward the inside wall 416 of the knob 406. The forwardly and rearwardly-extending tabs 436, 438 are generally perpendicular to the plane of the slip disc 402. The rearwardly-extending tab 438 is positioned between two radial ribs 440, 442 (shown in FIG. 11) extending forwardly from the inside wall 416 of the knob 406. The radial ribs 440, 442 subtend about 35° at the common axis 382.

Reception of the rearwardly-extending tab 438 of the slip disc 402 between the two forwardly-extending radial ribs 440, 442 in the knob 406 limits rotation of the slip disc 402 relative to the knob 406 to about 35°, the angle between the ribs 440, 442. A forwardly-extending end 444 of the slip disc rotation spring 404 is inserted through a hole (not shown) in the slip disc 402 to secure the forwardly-extending end 444 of the slip disc rotation spring 404 to the slip disc 402. A rearwardly-extending end 446 of the slip disc rotation spring 404 is inserted through a hole 448 in a boss 450 extending forwardly from the inside wall 416 of the knob 406 to secure the rearwardly-extending end 446 of the slip disc rotation spring 404 to the knob 406. Thus, the slip disc rotation spring 404 biases the slip disc 402 in the clockwise direction 410 relative to the knob 406 to, in turn, bias the rearwardly-extending tab 438 of the slip disc 402 against the forwardly-extending radial rib 440 (FIG. 11) of the knob 406.

The locking plate 352 serves two functions. As in the first embodiment 30, the locking plate 352 cooperates with the detent plate 354 to allow only clockwise rotation of the knob 406 and the drive shaft 344 in direction 410, while preventing anticlockwise rotation of the knob 406 and the drive shaft 344 in direction 412. Also, the locking plate 352 cooperates with the slip disc 402 to provide a knob rotation limiter feature so that each time the knob 406 is pushed in and turned clockwise to unlock the hinge and locking assembly 330, the knob 406 must be first released before the knob 406 can be operated again to unlock the hinge and locking assembly 330 a second time. The detent plates 54, 354 in the two embodiments 30, 330 are generally similar.

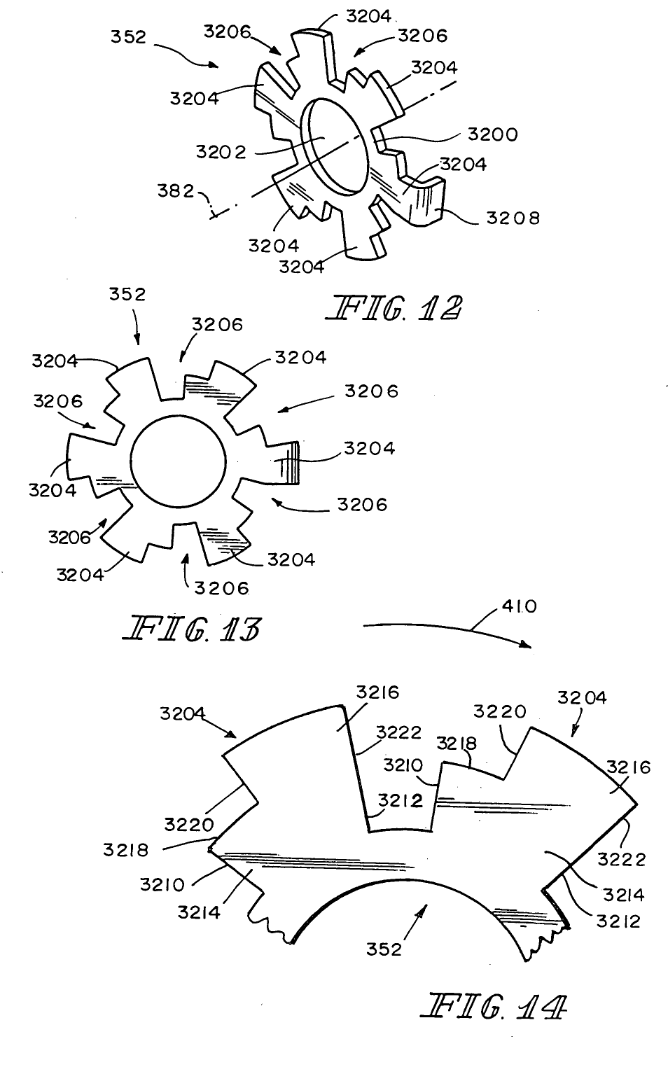

Referring to FIGS. 12-14, the locking plate 352 includes an annular portion 3200 having a central bore 3202 and six segments 3204 which extend radially outwardly from the annular portion 3200. The drive shaft 344 is configured to be rotatably received in the central bore 3202, and is freely rotatable therein. The six segments 3204 are separated by six cutouts 3206. Each of the six cutouts 3206 forms a 20° angle at the common axis 382. One of the segments 3204 is formed to include a positioning tab 3208 at one end thereof which extends perpendicularly from the plane of the locking plate 352. As in the first embodiment, the positioning tab 3208 is received in a positioning hole (not shown) in the rear support plate 350 to maintain the orientation of the locking plate 352 relative to the rear support plate 350. As shown in FIG. 14, each of the six segments 3204 has a stub portion 3214 that forms a 40° angle and an extended portion 3216 that forms a 25° angle at the common axis 382. Each stub portion 3214 and the associated extended portion 3216 form a step portion 3218 that forms a 15° angle at the common axis 382.

Each stub portion 3214 has a leading edge 3210 and a trailing edge 3212. As in the first embodiment, the leading and trailing edges 3210, 3212 of the stub portions 3214 of the locking plate 352 cooperate with the respective detent portions 3224 (FIG. 9) of the detent plate 354 to block anticlockwise rotation of the drive shaft 344 in direction 412, while allowing clockwise rotation thereof in direction 410. Each extended portion 3216 of the locking plate 352 has a leading edge 3220 and a trailing edge 3222. The leading and trailing edges 3220, 3222 of the extended portions 3216 of the locking plate 352 cooperate with the three forwardly-extending tabs 436 of the slip disc 402 to provide the knob rotation limiter feature. The forwardly-extending tabs 436 of the slip disc 402 are dimensioned to engage the leading and trailing edges 3220, 3222 of the extended portions 3216 of the locking plate 352 when the knob 406 is pushed in to unlock the hinge and locking assembly 330. However, it is noted that the forwardly-extending tabs 436 of the slip disc 402 are sufficiently spaced apart to provide radial clearance for the detent plate 354 so that the detent plate 354 can rotate with the drive shaft 344 when the knob 406 is pushed in and rotated without any hindrance from the forwardly-extending tabs 436 of the slip disc 402.

The assembly and operation of the hinge and locking assembly 330 is similar to the operation of the hinge and locking assembly 30 except that the hinge and locking assembly 330 has knob rotation limiter and the hinge lock indicator features. As previously indicated, the knob rotation limiter feature limits the rotation of the knob 406 to about 60° to 70° each time the knob 406 is pushed inward and turned clockwise in direction 410 to unlock the hinge and locking assembly 330. The knob 406 must be first released so that the slip disc 402 resets itself before the knob 406 can be operated again to unlock the hinge and locking assembly 330 a second time. The hinge lock indicator feature provides visual indication to the user when the hinge and locking assembly 330 is locked.

As indicated above, the locking plate 352 cooperates with the detent plate 354 to block anticlockwise rotation of the knob 406, the drive shaft 344 and the lifting cam 346 in direction 412. When the knob 406 is not pushed in, the locking bar 338 blocks rotation of the lifting cam 346 in the clockwise direction 410 to, in turn, block the rotation of the drive shaft 344 and the knob 406 in the clockwise direction 410. When the knob 406 is pushed in, the knob 406, the drive shaft 344 and the lifting cam 346 can be rotated in the clockwise direction 410. When the knob 406 is pushed in, (1) the locking bar support pin 336 is pushed in because the locking bar support pin 336 extends through the drive shaft 344 and engages the boss 415 on the inside wall 416 of the knob 406, (2) the locking bar 338 is pushed in against the bias of the snap spring 340 because the locking bar 338 is fixed to the locking bar support pin 336, (3) the locking tabs 3108 (FIG. 9) partially retract out of the tab-receiving slots 378 or 380 in the rear support plate 350, but not enough to free the support plates 348, 350 to rotate relative to each other, and (4) the locking bar 338 no longer blocks rotation of the lifting cam 346 in the clockwise direction 410 to, in turn, free the drive shaft 344 and the knob 406 to rotate in the clockwise direction 410.

At this point, with the knob 406 pushed in, the knob assembly 368 is at a starting position of a new unlocking cycle or sequence. At the starting position, (1) the forwardly-extending tabs 436 of the slip disc 402 are just past the respective trailing edges 3222 (FIG. 14) of the locking plate 352 secured to the rear support plate 350, and (2) the rearwardly-extending tab 438 of the slip disc 402 is positioned between the first and second radial ribs 440, 442 (FIG. 11) extending forwardly from the inside wall 416 of the knob 406. The rearwardly-extending tab 438 of the slip disc 402 is normally in engagement with the first radial rib 440 of the knob 406 under the bias of the slip disc rotation spring 404.

With the knob 406 pushed in, the knob 406 is rotated in the clockwise direction 410. The slip disc 402 rotates with the knob 406 in the clockwise direction 410 under the bias of the slip disc rotation spring 404. The knob 406 is rotated clockwise until the forwardly-extending tabs 436 of the slip disc 402 engage the respective leading edges 3220 (FIG. 14) of the locking plate 352 (i.e., about 35°). The engagement of the forwardly-extending tabs 436 of the slip disc 402 with the respective leading edges 3220 of the locking plate 352 block further rotation of the slip disc 402. The 35° angle corresponds to the angle between the trailing edge 3222 of a segment 3204 of the locking plate 352 and the leading edge 3220 of the next segment 3204 of the locking plate 352 (as viewed from the end 326 of the assembly 330). While the rotation of the slip disc 402 is blocked at this point by the locking plate 352, the knob 406 is allowed to rotate further in the clockwise direction 410 against the bias of the slip disc rotation spring 404 until the rearwardly-extending tab 438 of the slip disc 402 moves away from the first radial rib 440 (FIG. 11) of the knob 406 and engages the second radial rib 442 (FIG. 11) of the knob 406 (i.e., about 35°), at which point the knob 406 is blocked from continued clockwise rotation in direction 410. The 35° angle corresponds to the angle between the first and second radial ribs 440, 442 of the knob 406.

The clockwise rotation of the knob 406 in direction 410 by about 70°, causes clockwise rotation of the drive shaft 344 and the lifting cam 346, also through about 70°. The clockwise rotation of the lifting cam 346 by about 70° causes the locking bar 338 to move away from the support plates 348, 350 and, in turn, causes the locking tabs 3108 (FIG. 9) of the locking bar 338 to retract from the tab-receiving slots 378, 380 in the rear support plate 350 to free the support plates 348, 350 to rotate relative to each other. The support plates 348, 350 may then be rotated to a step ladder configuration, to an extension ladder configuration or to a collapsed configuration as the case may be, at which point the locking tabs 3108 of the locking bar 338 snap back into the tab-receiving slots 378, 380 in the rear support plate 350 under the bias of the snap spring 340 to again lock the support plates 348, 350 in place. The knob 406 is then released.

When the knob 406 is released (1) the knob 406 moves away from the rear support plate 350 under the bias of the knob spring 358, and (2) the slip disc 402 moves with the knob 406 away from the locking plate 352 so that the forwardly-extending tabs 436 of the slip disc 402 disengage from the respective leading edges 3220 of the locking plate 352 to free the slip disc 402 to rotate clockwise under the bias of the slip disc rotation spring 404 until the rearwardly-extending tab 438 of the slip disc 402 re-engages the first radial rib 440 of the knob 406 (i.e., about 35°). Thus, the slip disc 402 is reset or advanced to the starting position of a next unlocking cycle, where the knob 406 is again ready to be pushed in and rotated in the clockwise direction 410 to unlock the hinge and locking assembly 330.

1. For use with a hinge and locking assembly comprising a first support plate, a second support plate coupled to the first support plate for pivoting movement about an axis, and a knob rotatable about the axis and movable axially along the axis between a first axial position and a second axial position, the knob having a pair of stop members, a rotation limiter comprising
a lock member coupled to the second support plate, the lock member having a pair of radial segments,
a slip disc rotatable about the axis, the slip disc having first and second tabs, the first tab being configured for receipt between the radial segments of the lock member when the knob is moved from the first position to the second position, and the second tab being received between the stop members, and
a spring arranged to bias the slip disc for rotation with the knob.

2. The rotation limiter of claim 1, wherein the slip disk rotates with the knob in a first direction during movement of the knob through a first angular displacement corresponding to movement of the first tab between the radial segments, and wherein the knob continues to rotate in the first direction relative to the slip disk through a second angular displacement corresponding to movement of the second tab between the stop members.

3. The rotation limiter of claim 2, wherein the first and second angular displacements are each about 35°.

4. The rotation limiter of claim 2, wherein the first direction is a clockwise direction.

5. The rotation limiter of claim 1, wherein the hinge and locking assembly comprises a drive shaft rotatable about the axis, wherein the first support plate, the second support plate and the lock member are rotatably mounted on the drive shaft, wherein the knob is mounted on the drive shaft for rotation therewith, wherein the knob includes a hub portion, and wherein the slip disc is rotatably mounted on the hub portion between the lock member and the knob.

6. The rotation limiter of claim 5, wherein the drive shaft has a non-round portion, and wherein the hub portion of the knob has a complementary non-round bore for receiving the non-round portion of the drive shaft such that the knob is movable axially along the drive shaft between the first and second positions while transmitting the rotation of the knob to the drive shaft.

7. The rotation limiter of claim 6, wherein the non-round portion of the drive shaft and the non-round bore of the hub portion of the knob are both generally triangular in cross section.

8. The rotation limiter of claim 7, wherein the hub portion is generally triangle-shaped in cross section, and wherein the triangular-shaped hub portion has rounded corner portions to facilitate rotation of the slip disc relative to the knob.

9. The rotation limiter of claim 8, comprising a lock washer configured to be mounted on the hub portion of the knob, wherein the rounded corner portions of the knob are formed include outwardly-extending step portions, and wherein the slip disc and the spring are positioned on the hub portion between the lock washer and the step portions.

10. The rotation limiter of claim 1, wherein the hinge and locking assembly comprises a knob spring positioned between the second support plate and the knob for biasing the knob away from the second support plate, and wherein the first tab is configured for receipt between the radial segments of the lock member when the knob is moved toward the second support plate against the bias of the knob spring.

11. The rotation limiter of claim 1, comprising a lock washer, wherein the knob includes a hub portion, wherein the lock washer is configured to be mounted on the hub portion of the knob, wherein the hub portion is formed to include a step portion, and wherein the slip disc and the spring are rotatably mounted on the hub portion between the step portion and the lock washer.

12. The rotation limiter of claim 1, wherein the lock member includes an annular portion having a central bore, six radial segments extending outwardly from the annular portion and six tab-receiving spaces separating the six radial segments, and wherein the drive shaft is configured to be rotatably received in the central bore of the lock member.

13. The rotation limiter of claim 12, wherein one of the radial segments is formed to include a positioning tab configured for receipt in a positioning hole in the second support plate to maintain the orientation of the lock member relative to the second support plate.

14. The rotation limiter of claim 13, wherein each of the six tab-receiving spaces forms a 35° angle relative to the axis, and wherein each of the six radial segments forms a 25° angle relative to the axis.

15. The rotation limiter of claim 14, wherein the slip disc has three tabs which extend forwardly toward the support plates and one tab which extends rearwardly toward the knob, wherein the three forwardly-extending tabs are spaced about 120° apart relative to the axis, and wherein the forwardly and rearwardly-extending tabs are generally perpendicular to the plane of the slip disc.

16. The rotation limiter of claim 1, wherein the stop members extend forwardly from an inside wall of the knob and form about 35° at the axis.

17. The rotation limiter of claim 16, wherein the reception of the second tab between the stop members limits rotation of the knob relative to the slip disc to about 35°.

18. The rotation limiter of claim 1, wherein the hinge and locking assembly includes a detent member mounted on the drive shaft for rotation therewith and positioned on the drive shaft between the lock member and the slip disc, and wherein the detent member cooperates with the lock member to allow rotation of the drive shaft in a first direction while blocking rotation of the drive shaft in a second direction while.

19. The rotation limiter of claim 18, wherein the first direction is a clockwise direction, and wherein the second direction is an anticlockwise direction.

20. The rotation limiter of claim 18, wherein the first tab of the slip disc is positioned so that the detent member can rotate with the drive shaft when the knob is rotated without hindrance from the first tab.

21. For use with a hinge and locking assembly comprising a first support plate, a second support plate coupled to the first support plate for pivoting movement about an axis and a knob rotatable about the axis and movable axially along the axis between a first axial position and a second axial position, the second support plate having a first tab-receiving space, the knob having a second tab-receiving space, a rotation limiter comprising a slip disc rotatable about the axis, the slip disk having a first tab and a second tab, the first tab moving into the first tab-receiving space when the knob is moved from the first position to the second position, the second tab being received in the second tab-receiving space.

22. The rotation limiter of claim 21, wherein the slip disk rotates with the knob in a first direction during movement of the knob through a first angular displacement corresponding to movement of the first tab through the first tab-receiving space, and wherein the knob continues to rotate in the first direction relative to the slip disk through a second angular displacement corresponding to movement of the second tab relative to the second tab-receiving space.

23. A hinge and locking assembly comprising
a first hinge member,
a second hinge member coupled to the first hinge member for pivoting movement about an axis, the second hinge member having a first tab-receiving space,
a knob rotatable about the axis and movable axially along the axis between a first axial position and a second axial position, the knob having a second tab-receiving space, and
a slip disk rotatable about the axis, the slip disk having a main portion, a first tab and a second tab, the first tab moving into the first tab-receiving space when the knob is moved from the first position to the second position, the second tab being received in the second tab-receiving space, the slip disk rotating with the knob in a first direction during movement of the knob through a first angular displacement corresponding to movement of the first tab through the first tab-receiving space, and the knob continuing to rotate in the first direction relative to the slip disk through a second angular displacement corresponding to movement of the second tab relative to the second tab-receiving space.

24. A locking hinge apparatus comprising
first and second hinge members coupled together for rotation about an axis,
a lock movable between a locking position in which the first and second hinge members are prevented from rotating about the axis and a releasing position in which the first and second hinge members are permitted to rotate about the axis,
a knob rotatable about the axis and movable along the axis, the lock moving from the locking position to the releasing position in response to movement of the knob axially toward the first and second hinge members and then rotation of the knob about the axis, and
a rotation limiter configured to limit the amount that the knob is able to rotate each time the knob is moved along the axis toward the first and second hinge members.
